(19) United States
(12) Patent Application Publication
(10) Pub. No.: US 2013/0022781 A1
(43) Pub. Date: Jan. 24, 2013

(54) All Weather Adjustable Holiday Column Wrap

(71) Applicant: Cathy Ann Allen, Lakeland, FL (US)

(72) Inventor: Cathy Ann Allen, Lakeland, FL (US)

(21) Appl. No.: 13/186,252

(22) Filed: Jul. 19, 2011

(51) Int. Cl. B32B 3/24; C08F 210/00

(52) U.S. Cl. 428/131; 526/348

(57) ABSTRACT

Adjustable Holiday Column Wrap constructed of Weather Proof vinyl material to wrap around decorative or support column allowing holiday decorating without utilization of electricity or complicated application. Constructed to be cost effective and adjustable to fit various heights and circumferences of decorative columns. The wrap allows decorating for holidays with ease of application and storage. Cord or straps used to apply Wrap through a flap system, allowing for different size columns. The Wrap has an attached extension piece, enabling modification of the wrap to fit different size columns while covering the entire circumference of the column. Different holiday designs can be imprinted on the surface allowing easy decorating. Utilize holiday designs such as, but not limited to Toy Soldier, Santa Claus, Uncle Sam, Pilgrims, or Halloween designs.

### BACKGROUND OF INVENTION

Holiday decorations have become more complicated, more expensive, require more electricity and have a very short life cycle due to variations in environment and use of flimsy materials in construction.

Utilizing a weather proof marine grade vinyl column wrap to enhance residential holiday decorations is a cost efficient way of decorating without sacrificing quality .

The ability to adjust the size of the wrap both in circumference and in height makes the column wrap functional for different size columns through a cord and grommet system featuring an extension piece.

Because the column wrap requires no electricity, it functions without a power source for both ease of use and money savings in energy.

### PRIOR ART

Using a sheet of some kind to wrap a natural or upright utilitarian pole is well known. However, all previous items searched have no way to adjust both height and circumference and are not weatherproof for all environments to allow for holiday decor under any weather condition.

U.S. Pat. No. 6,363,644 by Frost, shows a pole wrap of a burlap sheet to produce a totem pole. The design is neither adjustable nor viable in wet weather.

U.S. Pat. No. 5,016,388 by Burress, shows a protective tree guard from polymeric filaments to make a webbing to protect a small tree when applied.

U.S. Pat. No. 5,408,782 by McConnell is for use by a hunter in providing insulated covering for sitting.

U.S. Pat. No. 5,383,296 by Vecchione is used as a flexible display banner around a pole to advertise or give informational messages while using existing upright structures.

U.S. Pat. Nos. 5,067,547; 5,553,433; 4,912,901; 4,961,258; 5,271,878; 6,192,646; 5,853,167 all show some kind of pole cover for utilitarian purposes, which are complex and expensive to construct without offering size adjustments and weather proof decor for the residential trade.

### SUMMARY OF INVENTION

This invention describes a simple way of making a decorative column wrap for holidays that is both functional, adjustable, inexpensive, long lasting and allows for holiday decor without the use of electricity or batteries.

The decorative column wrap is made of marine grade heavy vinyl, which will hide any imperfections or uneven surfaces on the column. It is attached to the column with a simple cord and grommet lacing design, using a grommet flap and an extension piece so the wrap can be adjusted to the circumference of the column.

The height of the column can also be accommodated with a scissor trim-able top and bottom of the wrap. The imprinted figure on the wrap is designed in a way allowing for trimming the top and bottom which will not affect the design.

The column wrap can be imprinted with any number of holiday figures, including but not limited to a Christmas Nutcracker, an Easter Bunny, Uncle Sam, Witch, Halloween Spooky Tree, Pilgrims, Santa Claus etc.

### DESCRIPTION OF DRAWINGS

FIG. 1.1—This indicates the extension flap attached to the flattened wrap to enable the wrap to be customized as to the varying circumferences of different columns. The extension will keep the entire column covered by the wrap, but will allow the lacing to be loosened as needed to fit the circumference of the column

FIG. 1.2—Shows the trim area of the wrap that will not affect the imprinted design. This allows for the wrap to be used on various height columns.

FIG. 2.1—Shows the lacing used between the grommets on one side and the grommet flap on the other side, to allow for expansion of the column wrap to fit various column circumferences. It is a simple “shoe lacing” system which can be loosened or tightened, allowing the wrap to be adjusted to fit.

FIG. 2.2—Shows the grommet flap which allows for the lacing to be adjusted with the use of the attached extension piece. If the grommets were placed without the flap, there would be no way to add an extension piece with the lacing system.

FIG. 2.3—Shows how the extension piece is used during the fitting of the wrap to the column.

### DETAILED DESCRIPTION OF THE INVENTION

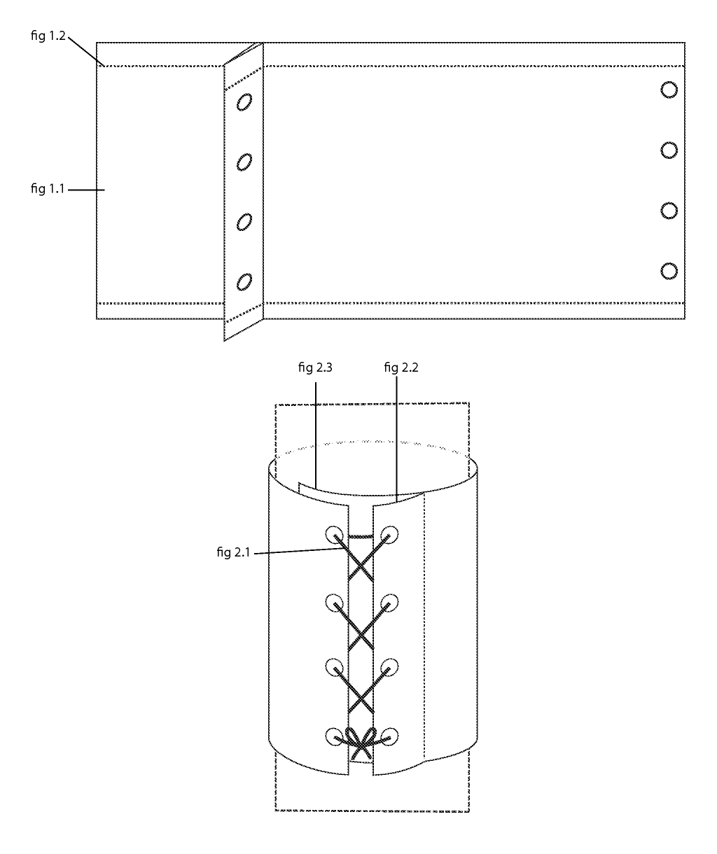

Referring to the drawings, the Holiday Column Wrap is show in FIGS. 1 and 2. The adjustable column wrap is made of a rectangular piece of weather grade vinyl, and is imprinted with a design to represent a holiday for decoration for residential decorative columns. The design is of the quality to withstand any weather conditions from ice to extreme heat and sun, without cracking, fading or degrading due to atmospheric conditions. It is then wrapped in a cylindrical fashion, around the column to decorate the column with a holiday design or figure which will be imprinted on the wrap.

FIG. 1.2—If necessary to fit the column height, the wrap is then trimmed from the top and/or the bottom with scissors. Because the material used is heavy vinyl, there is no need to sew or hem the edges after trimming.

As shown in FIG. 2.1, the column wrap is then raised and wrapped around the column. The heavy vinyl material allows the wrap to be used even when the column has an uneven surface.

The wrap is then pulled tight and laced with a synthetic cord, using the grommet flap as shown in FIG. 2.2. Because of the nature of the grommet flap, the lacing utilizes the extension piece shown in FIG. 2.3.

The extension piece can then be used to expand or decrease the size of the wrap to fit the column circumference by loosening or tightening the lacing. This allows not only for expansion, but also for the entire column to be covered during the expansion.

This system is simple, easy to use and allows for modification of the wrap both in width and height to fit the column being used.

1. A holiday column wrap giving end user a viable decorating option without electricity

2. Made of all weather marine grade vinyl to withstand change of environment from ice to heat, from rain to extreme sun.

3. Adjustable through the use of a grommet and cord system and design for trimming bottom and top using simple scissors without sewing, fraying or loss of design.

4. Design allows for different holiday images to be imprinted on the same basic vinyl shell without modification to the wrap

5. Design of the column wrap is easy and economical to make while giving end user a variety of sizes.
